(19) United States
(12) Patent Application Publication
(10) Pub. No.: US 2025/0286912 A1
(43) Pub. Date: Sep. 11, 2025

(54) SECURITY TOOL USING DATABASE HOOKS WITH ARTIFICIAL INTELLIGENCE

(71) Applicant: Stephen Roy Franklin, II, Chapin, SC (US)

(72) Inventor: Stephen Roy Franklin, II, Chapin, SC (US)

(21) Appl. No.: 19/068,112

(22) Filed: Mar. 3, 2025

Related U.S. Application Data
(60) Provisional application No. 63/562,984, filed on Mar. 8, 2024.

(51) Int. Cl. H04L 9/40

(52) U.S. Cl. CPC H04L 63/20

(57) ABSTRACT

A network security tool having Artificial Intelligence capabilities is provided. The network security tool can be implemented on a computing system including a processor and memory and can function to receive question(s) from a user and provide one or more response(s) to the question(s) based on processing by Artificial Intelligence. The network security tool can be system agnostic and can access data from both local system resources, and remote resources to provide the one or more response(s).

### CROSS-REFERENCE TO RELATED APPLICATION

This application claims benefit to Provisional Application No. 63/562,984, filed Mar. 8, 2024, the contents of which are herein incorporated by reference.

### BACKGROUND

### Field of Endeavor

The present disclosure relates to network and computer security, and more specifically, to a system agnostics network and computer security tool.

### Background and Related Art

Network security is a key concern to organizations in the digital age, as organizations seek to limit network downtime, and resulting losses in productivity and revenue. Network security systems prevent, or mitigate network downtime resulting from component failure, system attacks, unauthorized access, data loss, etc. However, current systems rely on large collections of data and allow for information to be read by a human, which allows the human to make a corresponding decision. Furthermore, these systems are typically domain specific, residing on an organization's network. These systems are disadvantageous due to their reliance on a human-in-the-loop to make decisions, resulting in less efficient decision making.

As can be seen, there is a need for security tools that address the above drawbacks.

### SUMMARY OF THE INVENTION

In today's digital landscape, network and computer security are critical concerns for organizations striving to protect their data and maintain operational continuity. As cyber threats become increasingly sophisticated, traditional network security systems face significant challenges. These systems often rely on extensive data collection and manual analysis by human operators, which can lead to inefficiencies and delayed responses to security incidents. Moreover, many existing security solutions are domain-specific, tailored to the specific infrastructure of individual organizations, which limits their adaptability and scalability.

The reliance on human intervention in current security systems presents several disadvantages. Human operators are required to possess comprehensive knowledge of the systems they monitor and the context of the data they analyze. This requirement not only demands highly skilled personnel but also introduces the potential for human error. Additionally, the manual nature of these processes can result in slower decision-making, which is of great importance in the fast-paced environment of network security. Furthermore, the need for domain-specific solutions means that organizations are required to invest in customized security tools, which can be costly and time-consuming to implement and maintain.

The present system addresses these challenges by introducing a network security tool that is independent of specific systems and leverages artificial intelligence (Al) and machine learning to enhance security operations. This tool is designed to operate across various network environments without requiring extensive customization. By utilizing Al, the security tool can autonomously process and analyze data, providing real-time insights and responses to security threats. The tool's ability to understand and interpret plain language queries allows users to interact with the system intuitively, reducing the need for specialized knowledge. Additionally, the integration of a self-healing module enables the system to automatically implement corrective actions, further minimizing the need for human intervention and enhancing the overall efficiency of security operations.

In one embodiment, the disclosure includes a network security system comprising at least one processor and at least one memory storing instructions that, when executed by the processor, perform a method. The method includes receiving, at a chat interface, one or more questions; processing, using a Large Language Model of the chat interface, the one or more questions to determine one or more attributes; querying, using the one or more attributes, one or more data sources to return one or more data sets; processing, using the Large Language Model, the one or more data sets to form one or more responses; and outputting, to the chat interface, the one or more responses.

The network security system includes one or more responses that include one or more of the one or more data sets, one or more questions, or one or more links to one or more applications. Additionally, the one or more attributes include one or more of a data location required by the one or more questions or a data type required by the one or more questions. The network security system comprises a self-healing module configured to implement one or more corrective actions. The system also includes evaluating, by the chat interface, the one or more questions to determine one or more response formats, wherein outputting, to the chat interface, the one or more responses, outputs the one or more responses using the one or more response formats.

In yet another embodiment, the disclosure includes a computer-implemented method of detecting and rectifying security of a system, comprising receiving one or more questions from a user; processing, using a Large Language Model of the chat interface, the one or more questions to determine one or more attributes; querying, using the one or more attributes, one or more data sources to return one or more data sets; processing, using the Large Language Model, the one or more data sets to form one or more responses; and outputting, to the chat interface, the one or more responses. The method further includes one or more responses that include one or more of the one or more data sets, one or more questions, or one or more links to one or more applications. These and other features will be more clearly understood from the following detailed description taken in conjunction with the accompanying drawings and claims.

### BRIEF DESCRIPTION OF THE DRAWINGS

FIG. 1 is a flow chart of a security process, according to aspects of the present disclosure;

FIG. 2 is another flow chart of a security process, according to aspects of the present disclosure; and

FIG. 3 is another flow chart of a process performed by an artificial intelligence (AI) chat tool.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, current security process rely on a human operator having all relevant information to make a security decision. Additionally, the human operator needs to understand the context of all the relevant information. Moreover, most monitoring and security solutions require knowledge of the systems they are monitoring and also require high-level staff to interact and read complex reports.

Broadly, an embodiment of the present disclosure provides system agnostic network and security tool that uses artificial intelligence (AI) machine learning to understand a network and computer environment the security tool is monitoring so that simple plain English queries can be used to solve complex issues. The security tool uses AI to read information and understand the system's context and complex systems to make informed responses to queries from human operators without the requisite knowledge or context.

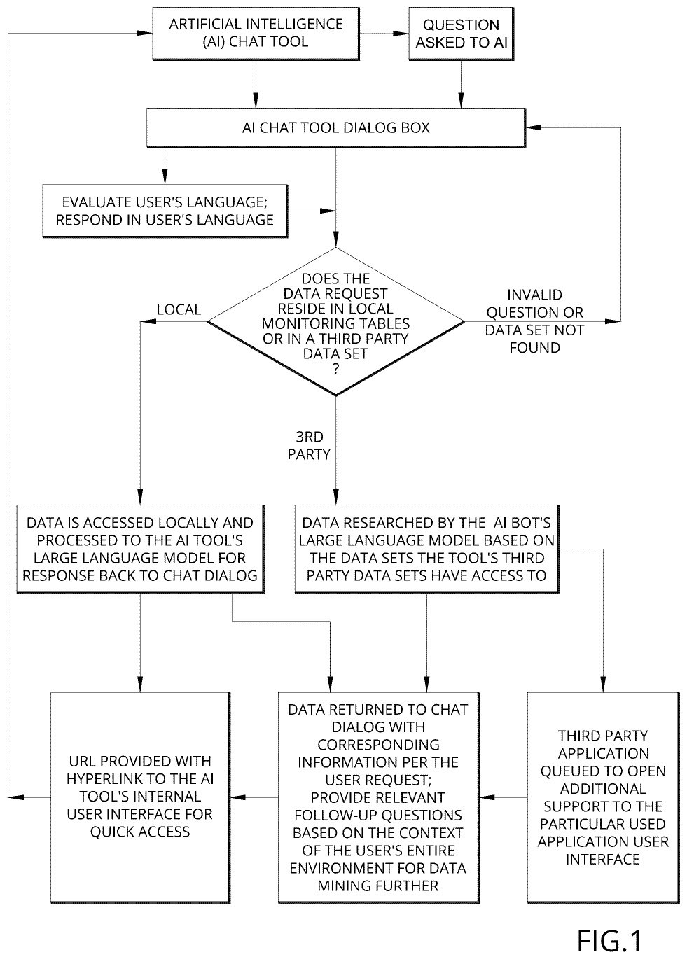

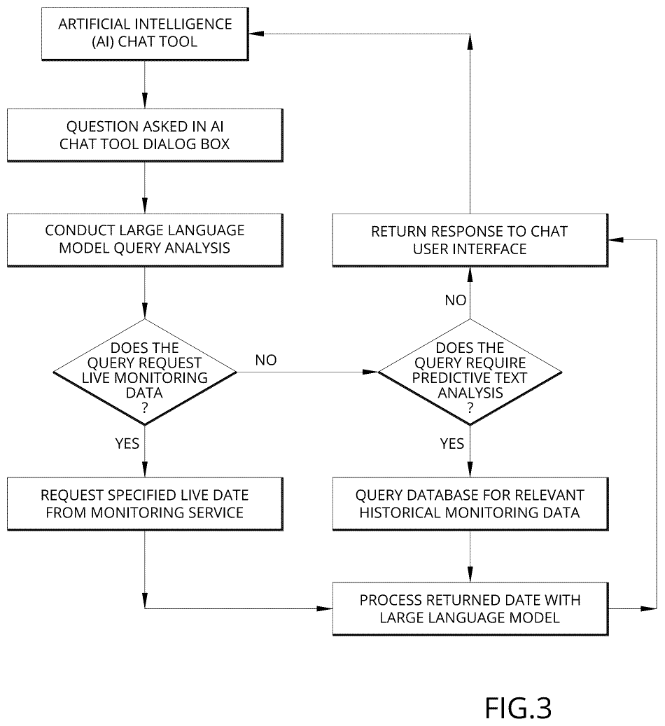

Referring now to FIGS. 1-3, FIGS. 1 and 3 illustrate a security process using AI, according to aspects of the present disclosure. In one example, the process can be performed by a security tool. While FIGS. 1 and 3 illustrate examples of stages of the security process, additional stages can be added and existing stages can be removed and/or modified.

Referring now to FIG. 1, the process can begin by executing a security tool that includes an AI chat interface. Next, a user inputs a question, or query, in a dialog box (or input interface) of the chat interface. Once the question is received, the AI chat bot evaluates the user language to determine a response format that matches the user's language. The format can include the type of language, the dialect, the level of language comprehension, etc. Advantageously, the response format is utilized to formulate one or more responses to the question in a format most easily recognizable and digestible by the user.

Then, the security tool determines if the question is valid or if the data resides in local monitoring tables or in third-party data sets. If the question is not valid or the data sets are not found, an error is returned to the chat interface.

If the data set is local, the data set is accessed locally and fed to a Large Language Model of the security tool to generate a response for the chat interface. In embodiments, the data set is returned to the chat interface with the corresponding information per the user question. Additionally, relevant follow-up questions can be provided based on the context of the overall computing environment of the user, which can allow further data mining. In embodiments, the security tool can be trained on topics related to the overall context of the computing environment, such that the tool intuitively knows the information needed to make proper determinations, judgments, recommendations, etc., and can provide the relevant follow-up questions to that end. In embodiments, a network location (e.g., a URL provided with a hyperlink, can be provided that allows for quick access to information).

If the data set is held by a third party, data available in the third-party data set is fed to the Large Language Model of the security tool to generate one or more response(s) for the chat interface. In embodiments, a third-party application can be linked to the security tool to provide additional support. For example, An example of a third-party application can be Nmap, a security tool that is used to monitor network vulnerabilities like open ports. In this example Nmap can scan and identify open ports and store the Internet Protocol address (IP) range and ports open or closed in the network under analysis. The security tool uses those data points in the entire context of the data set. For example, port 80 should be open on a WEB server but not open on a domain controller. The tool knows the difference and interacts with the data set to answer questions posed to security threats with collected data in the base native product and the third-party application, in this case Nmap, to give a “more complete” answer back.

In embodiments, data is returned to the chat interface with the corresponding information per the user query, which can include the one or more responses. Additionally, relevant follow-up questions can be provided based on the context of the overall computing environment of the user, which can allow further data mining. In embodiments, a network location (e.g., a URL provided with a hyperlink, can be provided that allows for quick access to information. In embodiments, all data returned to the chat interface can be formatted in accordance with the response format, such that the information is easily understood and digestible by the user.

Referring now to FIG. 3, a sub-process of FIG. 1 is illustrated. The process can begin by executing a security tool that includes an AI chat interface. Next, a user inputs a question, or query, in a dialog box (or input interface) of the chat interface. Once the question is received, the AI chat bot evaluates the question, using the Large Language Model to determine one or more attributes of the question. In an embodiment, the one or more attributes of the question can include attributes related to the type of data sought by the question, such as live monitoring data and/or predictive text analysis. If no live monitoring data is required, and no predictive text analysis is required, the process may continue at the data set determination of FIG. 1, and a data set is returned to the chat interface with the corresponding information per the user question, as outlined in FIG. 1.

If live data monitoring is required, one or more live data sets can be provided from one or more monitoring services. In an embodiment, the one or more live data sets can be processed by the Large Language Model and returned to the chat interface as one or more responses to the question. In an embodiment, the Large Language Model can be updated using live data through a messaging service of one or more databases, or one or more function calls to one or more Application Programming Interfaces (API) can be made to fetch data needed, live and in real-time.

If live data monitoring is not required, the tool can determine if predictive text analysis is provided. If predictive text analysis is required, the tool can query one or more databases for one or more historical data sets. In an embodiment, the one or more historical data sets can be processed by the Large Language Model and returned to the chat interface as one or more responses to the question. In embodiments, the one or more historical data sets can be processed by one or more analysis techniques, one or more prediction techniques, and/or one or more response generations.

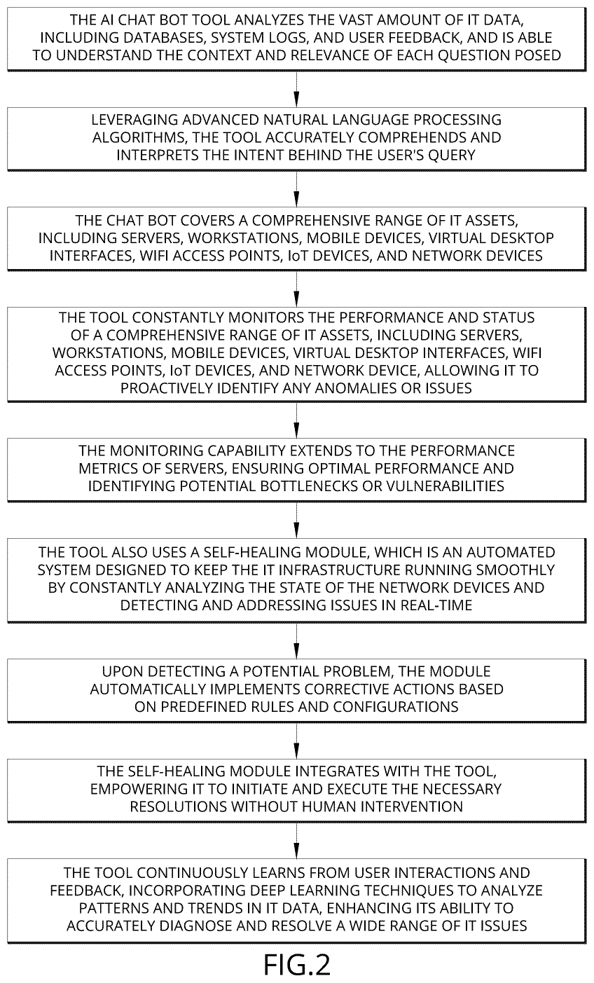

Referring now to FIG. 2, another security process using AI, according to aspects of the present disclosure. In one example, the process can be performed by a security tool. While FIG. 2 illustrates examples of stages of the security process, additional stages can be added, and existing stages can be removed and/or modified.

In embodiments, the AI chat bot can analyze the vast amount of information technology data including databases, system logs, and user feedback. The AI chat bot can be trained to understand the context and relevance of each query or question that is posed by a user. In an embodiment, data is collected by each data point collected and stored by the corresponding connected tool. The AI chat tool uses these as the data set for the target environment it is answering questions on. As such the LLM is constantly learning more about the data sets and applying a personality. The personality changes based on the context of the question. The personality in most cases is a “system administrator” but if the question is more geared to a security/compliance request the personality is uses in the LLM is the CISO personality. Other personalities can include a threat hunting personality which uses both the sys admin and the CISO together.

In embodiments, the AI chat bot can leverage advanced natural language processing algorithms that allow the AI chat bot to accurately comprehend and interpret the intent behind the query of a user. The AI chat bot covers a comprehensive range of assets monitored by the security tool including, but not limited to, servers, workstations, mobile devices, virtual desktop interfaces, WiFi access points, Internet of Things (IoT) devices, network devices, and the like.

In embodiments, the security tool constantly monitors the performance and status of a comprehensive range of assets monitored by the security tool including, but not limited to, servers, workstations, mobile devices, virtual desktop interfaces, WiFi access points, Internet of Things (IoT) devices, network devices, and the like, allowing the security tool to identify any anomalies or issues. The monitoring capability extends to the performance metrics of servers, ensuring optimal performance and identifying potential bottlenecks or vulnerabilities. For example, metrics can define what is a “bot” and what is a “human” speed response and or active actions. For example, a human cannot send 200 emails at once or kick off a mass encryption event in parallel to a mass deletion event. The security tool also uses a self-healing module, which is an automated system designed to keep the IT infrastructure running smoothly by constantly analyzing the state of the network devices and detecting and addressing issues in real-time.

In embodiments, upon detecting a potential problem, the module automatically implements corrective actions based on predefined rules and configuration. The self-healing module integrates with the security tool, empowering it to initiate and execute the necessary resolution without human intervention. The security tool continuously learns from interactions with users and feedback from users. The security tool can incorporate deep learning techniques to analyze patterns and trend in IT data, enhancing its ability to accurately diagnose and resolve a wide range of IT issues.

In embodiments, the security and AI machine learning algorithms can be stored and executed on a computing system. The computing system includes a processing device coupled to a communication device. The processing device is also coupled to a memory device, and an input/output (“I/O”) interface. In embodiments, the communication interface enables the computing system to communicate with other devices and systems via one or more networks. The computing system can communicate with a user, operating a user device, via the network. The user device can include one or more electronic devices such as a laptop computer, a desktop computer, a tablet computer, a smartphone, a thin client, and the like.

According to the aspects of the present disclosure, the computing system can store and execute a copy of the security tool as described above. Likewise, the user device can store and execute a copy of the security tool as described above or another application. The application enables the user operating the user device to communicate with the security tool of the computing system. In some embodiments, the application can be a specifically designed application that operates with security tool to perform the processes and methods described herein. In some embodiments, the application can be a third-party application, such as a web browser, that communicates with the computing system to perform the processes and methods described herein. The security tool and/or the application can include the necessary logic, instructions, and/or programming to perform the processes and methods described herein. The security tool and/or the application can be written in any programming language.

The memory device can also include a database that stores information and data associated with the process and methods described herein. The database can store data set that describe the overall computer systems and networks of the user. The database can be any type of database, for example, a hierarchical database, a network database, an object-oriented database, a relational database, a non-relational database, an operational database, and the like.

The security tool operates to generate and provide graphical user interfaces (GUIs) for example, menus, widgets, text, images, fields, dialog boxes, etc. and chat interfaces. The security tool can be configured to receive user queries and process the queries using AI machine learning algorithms as described above.

The processing device, the communication device, the memory device, and the I/O interface can be interconnected via a system bus. The system bus can be and/or include a control bus, a data bus, an address bus, and the like. The processing device can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. The computing system can include multiple processing devices, whether the same type or different types.

The memory device can be and/or include one or more computerized storage media capable of storing electronic data temporarily, semi-permanently, or permanently. The memory device can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. The computing system can include multiple memory devices, whether the same type or different types.

The communication device enables the computing system to communicate with other devices and systems. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long-term evolution (“LTE”) standard, and so forth.

The computing system can communicate with one or more network resources via the network. The one or more network resources can include external databases, social media platforms, search engines, file servers, web servers, or any type of computerized resource that can communicate with the computing system via the network.

In embodiments, the components and functionality of the computing system can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the computing system can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the computing system and the user device can include a user interface for outputting information in a format perceptible by a user and receiving input from the user The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A network security system, comprising:
At least one processor, and at least one memory storing instructions that when executed by the processor perform a method, the method comprising:
receiving, at a chat interface, one or more questions;
processing, using a Large Language Model of the chat interface, the one or more questions to determine one or more attributes;
querying, using the one or more attributes, one or more data sources to return one or more data sets;
processing, using the Large Language Model, the one or more data sets to form one or more responses;
outputting, to the chat interface, the one or more responses.

2. The network security system of claim 1, wherein the one or more responses includes one or more of:
the one or more data sets;
one or more questions; or
one or more links to one or more applications.

3. The network security system of claim 1, wherein the one or more attributes includes one or more of:
a data location required by the one or more questions; or
a data type required by the one or more questions.

4. The network security system of claim 1, further comprising:
a self-healing module configured to implement one or more corrective actions.

5. The network security system of claim 1, further comprising:
evaluating, by the chat interface, the one or more questions to determine one or more response formats, wherein outputting, to the chat interface, the one or more responses, outputs the one or more responses using the one or more response formats.

6. A computer-implemented method of detecting and rectifying security of a system, comprising:
receiving one or more questions from a user;
processing, using a Large Language Model of the chat interface, the one or more questions to determine one or more attributes;
querying, using the one or more attributes, one or more data sources to return one or more data sets;
processing, using the Large Language Model, the one or more data sets to form one or more responses;
outputting, to the chat interface, the one or more responses.

7. The method of claim 6, wherein the one or more responses includes one or more of:
the one or more data sets;
one or more questions; or
one or more links to one or more applications.

8. The method of claim 6, wherein the one or more attributes includes one or more of:
a data location required by the one or more questions; or
a data type required by the one or more questions.

9. The method of claim 6, further comprising:
receiving, in real-time, one or more states of one or more devices in the system;
analyzing, in real-time, the one or more states of the one or more devices to determine if there are one or more issues;
executing, in response to one or more issues being present, one or more corrective actions.

10. The method of claim 6, further comprising:
evaluating the one or more questions to determine one or more response formats, wherein outputting, to the chat interface, the one or more responses, outputs the one or more responses using the one or more response formats.
